(19) United States
(12) Patent Application Publication
(10) Pub. No.: US 2017/0287350 A1
(43) Pub. Date: Oct. 5, 2017

(54) METHOD AND SYSTEM FOR CREATING A SIMULATION PLAN FOR TRAINING PERSONNEL ON SYSTEM MAINTENANCE

(71) Applicant: CAE Inc., Saint-Laurent (CA)

(72) Inventors: Ghislain Giguere, Saint-Laurent (CA); Mikhail NEJELSKI, Saint-Laurent (CA); Thai Hoa VO, Saint-Laurent (CA)

(21) Appl. No.: 15/088,068

(22) Filed: Mar. 31, 2016

(51) Int. Cl. G09B 9/00; G06F 3/0484; H04L 29/08; G06F 17/50

(52) U.S. Cl. CPC G09B 9/00; G06F 17/5009; G06F 3/0484; H04L 67/32

(57) ABSTRACT

Method and system for creating a simulation plan required for development of an interactive computer simulation of an interactive simulated system for training personnel on maintenance of a system. The simulation plan is created in memory preserving content from a maintenance manual for the system. For each section identified in the simulation plan, a plurality of simulated components of the interactive simulated system are associated with one or more components of the system. A unique section descriptor is associated with each individual component of the plurality of simulated components. A simulation-specification is then assigned to each unique section descriptor for developing an interactive simulated maintenance procedure from the maintenance-action content. The simulation plan is then stored in memory with each simulation-specification. Development of the interactive computer simulation of the interactive system necessitates completion of every one of the simulation-specifications.

### PRIORITY STATEMENT

This non-provisional patent application claims priority based upon the PCT patent applications entitled “METHOD AND SYSTEM FOR CREATING A SIMULATION PLAN FOR TRAINING PERSONNEL ON SYSTEM MAINTENANCE”, filed on even date herewith, in the name of CAE Inc.

### TECHNICAL FIELD

The present invention relates to development of interactive computer simulations and, more particularly, to development of interactive maintenance simulated systems for training personnel on system maintenance.

### BACKGROUND

Interactive computer simulation systems are used to train personnel on complex and/or risky tasks. For instance, an interactive computer simulation may be used to train personnel for maintenance of complex systems (e.g., an aircraft, a ground vehicle, a space station, etc.) by allowing them to interact with corresponding simulated systems. In order for the training to be meaningful, the interactive computer simulation must, however, be able to train the personnel on the simulated systems in accordance with corresponding maintenance guides for the real systems. In that context, an interactive computer simulation is developed based on a given maintenance guide. The development is challenging considering the number of different computer simulation experts, having a wide range of expertise, that need to work on each maintenance action from the maintenance guide. The current development process leads to inefficiencies and undue delays.

The present invention at least partially addresses this shortcoming.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with a first set of embodiments, a first aspect is directed to a method is provided for creating, from a maintenance manual comprising a content describing maintenance actions to be performed on components of a system, a corresponding simulation plan required for development of an interactive computer simulation of an interactive simulated system for training personnel on maintenance of the system. The method comprises a) creating into memory the simulation plan of the interactive simulated system preserving the content comprising section markers from the maintenance manual and b) identifying a section in the simulation plan considering the section markers, the identified section comprising a maintenance-action content. The method also comprises c) associating, with the identified section, a plurality of simulated components of the interactive simulated system corresponding to one or more components of the system identified in the maintenance-action content, d) assigning a unique section descriptor to each individual component of the plurality of simulated components and e) assigning, to each of the unique section descriptors, a simulation-specification for developing an interactive simulated maintenance procedure of the interactive computer simulation from the maintenance-action content. The method then continues with f) storing into memory the simulation plan comprising the simulation-specifications for the identified section. Development of the interactive computer simulation of the interactive system necessitates completion of every one of the simulation-specifications.

Optionally, the method further comprises grouping at least two of the unique section descriptors of the individual components considering one or more of an underlying common behavior thereof, an underlying common transition trigger for transition thereof and a common sub-system filiation thereof.

Optionally, the simulation-specification may comprise i) a simulated initial state of the individual simulated component before execution of the interactive simulated maintenance procedure corresponding to a state of a corresponding component from a corresponding group of components in an initial state from the maintenance-action content, ii) a simulated condition, associated with the individual simulated component, to be triggered during execution of the interactive simulated maintenance procedure, compatible with transition-conditions from the maintenance-action content, iii) a simulated transition of the individual simulated component, taking place upon trigger of the simulated condition, compatible with a transition of the group of components from the maintenance-action content and iv) a simulated final stage of the individual simulated component after execution of the interactive simulated maintenance procedure, compatible a final state of the group of components from the maintenance-action content.

In some embodiments, creating into memory the simulation plan may further comprise locating the section markers in the maintenance plan by parsing one or more of marked-up language code, encoded document styles, detecting formatting patterns or detecting template markers, the simulation plan being encoded with marked-up language.

Assigning the unique section descriptor may optionally be performed by selecting a section template from a list of existing section templates considering an action type of the specific-action content. Assigning the unique section may also optionally be performed by creating a new section template considering an action type of the specific-action content and subsequently adding the new section template to a list of existing section templates.

The method may further comprise, in some embodiments, repeating b) to e) until all section markers from the content are parsed.

Each of the simulation-specifications may also optionally further comprise a plurality of ordered simulation-work-orders and the method may then further comprise, for each one of the plurality of ordered simulation-work-orders: sequentially receiving a retrieval request therefor from a remote network node over a network interface and subsequently receiving, from the remote network node over the network interface, a work-order completion therefor. The interactive simulated maintenance procedure is developed upon receipt of each one of the work-order completions for each one of the plurality of ordered simulation-work-orders.

The plurality of ordered simulation-work-orders may further comprise a first system-work-order for indicating an expected behavior of the system considered during the specific-action content from the content of the maintenance manual, a second simulation-work-order for indicating an expected simulated behavior of the simulated system during the interactive simulated maintenance procedure and a third design-work-order for preparing one or more animated sequences for displaying the expected simulated behavior of the simulated system during the simulated maintenance procedure. Deploying the interactive computer simulation of the interactive system may then further be performed by linking the developed interactive simulated maintenance procedures in accordance with the simulation plan.

Associating the one or more simulated components with the unique section descriptor may be performed, in some embodiments, by selecting at least one of the one or more simulated components from a list of existing unique components of the interactive simulated system. Associating the one or more simulated components with the unique section descriptor may also optionally be performed by selecting a new component for at least one of the one or more simulated components and wherein the simulation-specification comprises a creation request for creating the new component for the interactive simulated system and subsequently adding the new component to a list of existing unique components of the interactive simulated system.

In accordance with the first set of embodiments, a second aspect is directed to a computer system for creating a simulation plan required for development of an interactive computer simulation of an interactive simulated system for training personnel on maintenance of a system corresponding to the interactive simulated system. The computer system comprises a storage unit and a processor module. The storage unit is storing a maintenance manual comprising a content describing maintenance actions to be performed on components of the system and

the simulation plan of the interactive simulated system preserving the content comprising section markers from the maintenance manual. The processor module a) identifies a section in the simulation plan considering the section markers, the identified section comprising a maintenance-action content, b) associates, with the identified section, a plurality of simulated components of the interactive simulated system corresponding to one or more components of the system identified in the maintenance-action content, c) assigns a unique section descriptor to each individual component of the plurality of simulated components, d) assigns, to each of the unique section descriptors, a simulation-specification for developing an interactive simulated maintenance procedure of the interactive computer simulation from the maintenance-action content and e) updates, into the storage unit, the stored simulation plan comprising each one of the simulation-specifications for each one of the identified sections. Development of the interactive computer simulation of the interactive system necessitates completion of every one of the simulation-specifications.

The processor module may optionally further group at least two of the unique section descriptors of the individual components considering one or more of an underlying common behavior thereof, an underlying common transition trigger for transition thereof and a common sub-system filiation thereof.

The simulation-specification may comprise i) a simulated initial state of the individual simulated component before execution of the interactive simulated maintenance procedure corresponding to a state of a corresponding component from a corresponding group of components in an initial state from the maintenance-action content, ii) a simulated condition, associated with the individual simulated component, to be triggered during execution of the interactive simulated maintenance procedure, compatible with transition-conditions from the maintenance-action content, iii) a simulated transition of the individual simulated component, taking place upon trigger of the simulated condition, compatible with a transition of the group of components from the maintenance-action content and iv) a simulated final stage of the individual simulated component after execution of the interactive simulated maintenance procedure, compatible a final state of the group of components from the maintenance-action content.

The maintenance plan stored in the storage unit may optionally further comprise one or more of marked-up language code, encoded document styles, formatting patterns or template markers and the simulation plan stored in the storage unit is encoded with marked-up language.

The processor module assigns the unique section descriptor by i) selecting a section template from a list of existing section templates considering an action type of the specific-action content and ii) when no section template is selected, creating a new section template considering an action type of the specific-action content and subsequently adding the new section template to a list of existing section templates.

Each of the simulation-specifications may optionally comprise a plurality of ordered simulation-work-orders and the processor module may further, for each one of the plurality of ordered simulation-work-orders sequentially receive a retrieval request therefor from a remote network node over a network interface and subsequently receive, from the remote network node over the network interface, a work-order completion therefor. The interactive simulated maintenance procedure may be developed upon receipt of each one of the work-order completions for each one of the plurality of ordered simulation-work-orders.

The plurality of ordered simulation-work-orders may comprise i) a first system-work-order for indicating an expected behavior of the system considered during the specific-action content from the content of the maintenance manual, ii) a second simulation-work-order for indicating an expected simulated behavior of the simulated system during the interactive simulated maintenance procedure and iii) a third design-work-order for preparing one or more animated sequences for displaying the expected simulated behavior of the simulated system during the simulated maintenance procedure.

The processor module may further deploy the interactive computer simulation of the interactive system by linking the developed interactive simulated maintenance procedures in accordance with the simulation plan.

In accordance with a second set of embodiments, a second aspect is directed to a computer system for updating an original simulation plan into an updated simulation plan required for subsequent development of an updated interactive computer simulation of an interactive simulated system for training personnel on maintenance of the system, The computer system comprises a storage unit and a processor module. The storage unit stores an updated maintenance manual comprising an updated content describing updated maintenance actions to be performed on components of the system, an original simulation plan comprising a plurality of original section descriptors, the original simulation plan being created from an original content preserved in the original simulation plan from an original maintenance manual for the system and the updated simulation plan of the interactive simulated system preserving the updated content comprising section markers from the updated maintenance manual.

The processor module a) identifies one or more updated section descriptors in the updated simulation plan, comprising an updated maintenance-action content, considering the section markers and the plurality of original section descriptors, the updated maintenance-action content comprising an updated expected behavior of the system, b) when the updated maintenance-action content comprises a new component of the system, associates a new simulated component with the one or more updated section descriptors, c) updates a simulation-specification of the one or more updated section descriptors for developing one or more updated interactive simulated maintenance procedures from the updated maintenance-action content, d) adds a simulation-work-order to the simulation-specification for updating a simulated behavior of the simulated system during the updated interactive simulated maintenance procedure, e) adds a design-work-order for preparing one or more animated sequences for displaying the updated expected simulated behavior of the simulated system during the updated interactive computer simulation and f) stores, into the storage unit, the updated simulation plan comprising the simulation-specification. The development of the updated interactive computer simulation of the interactive system necessitates completion of the simulation-specification.

The processor module may further copy each undisturbed section descriptors from the original simulation plan into the updated simulation plan and the processor module may further store the updated simulation plan by storing the undisturbed original section descriptors from the original simulation plan together with each one of the updated simulation-specifications for the one or more updated section descriptors.

The processor module may further locate the section markers in the updated maintenance plan by parsing one or more of marked-up language code, encoded document styles, detecting formatting patterns or detecting template markers.

The processor module may further update the unique section descriptor by selecting a section template from a list of existing section templates considering an action type of the specific-action content or by creating a new section template considering an action type of the updated maintenance-action content and subsequently adding the new section template to a list of existing section templates.

The computer system may further comprise a network interface module. The processor module may further, for each one of the plurality of ordered simulation-work-orders, sequentially receive a retrieval request therefor from a remote network node over the network interface module and subsequently receive, from the remote network node over the network interface module, a work-order completion therefor. The updated interactive simulated maintenance procedure may be developed upon receipt of each one of the work-order completions for each one of the plurality of ordered simulation-work-orders.

The processor module may further deploy the updated interactive computer simulation of the interactive system by linking the developed updated interactive simulated maintenance procedures in accordance with the updated simulation plan.

The processor module may further associate the new simulated component with the one or more updated section descriptors by selecting the new simulated component from a list of existing unique components of the interactive simulated system.

The processor module may further associate the new simulated component with the one or more updated section descriptors by including a creation request for creating the new simulated component for the interactive simulated system in the simulation-specification and subsequently add the new simulated component to a list of existing unique components of the interactive simulated system.

The processor module may further repeat a) to e) for each of a plurality of updated sections in the updated simulation plan and for each new section in the updated simulation plan.

In an optional embodiment, a common aspect of multiple grouped updated section descriptors may be updated at once when one member thereof is updated.

### BRIEF DESCRIPTION OF THE DRAWINGS

Further features and exemplary advantages of the present invention will become apparent from the following detailed description, taken in conjunction with the appended drawings, in which:

FIG. 1 is logical modular representation of an exemplary computer system in accordance with the teachings of the present invention; and

FIG. 2, FIG. 3 and FIG. 4 are flow charts of exemplary methods in accordance with the teachings of the present invention.

### DETAILED DESCRIPTION

The present disclosure addresses issues that arise in the context of development and/or deployment of aircraft interactive maintenance training simulations. Skilled people will readily acknowledge that the challenges encountered in the aircraft maintenance context are likely to arise in other contexts and that, accordingly, the teachings of the present invention are portable to other contexts. Typically, an interactive maintenance training simulations provides a three-dimensional (3D) representation of procedures for a given system's instruction manual provided by an Original Equipment Manufacturer (OEM) (e.g., an aircraft maintenance instruction manual prepared by Airbus for a specific aircraft or a family of aircrafts). Procedures are analyzed by several computer-simulation experts, such as technicians, system engineers, and 3D designers, prior to be integrated in a computer generated environment for the interactive maintenance training simulation. For instance, for each maintenance action prescribed by the instruction manual, the interactive maintenance training simulation requires development and deployment (or integration) of multiple specific-action simulation constituents such as textual description(s), simulated part(s), interactive simulated (2D or 3D) component(s), preset animation(s), etc.

Updated maintenance instruction manuals are produced by the OEM for existing system for various reasons. For instance, the update may be triggered by implementation of a better procedure (e.g., from experience, feedback or regulation requirements), by the selection of a new or modified component (e.g., new hydraulic hoses), by the complete replacement of a sub-system (e.g., new landing gear from a different provider), by availability of a new optional system (e.g., new compatible turbo-fan), etc. The OEM therefore requests an update of the interactive maintenance training simulation. The new maintenance instruction manual is typically the only information received from the OEM concerning the required update. In other circumstances, a new maintenance instruction manual may be received for a system that shares a number of similarities with a system having its interactive maintenance training simulation.

Embodiments of the present invention allow creating a simulation plan for the interactive maintenance training simulation such that, when the updated manual is received, it supports reliable update of the existing interactive maintenance training simulation rather than development of a new simulation. By experience, updating an existing interactive maintenance training simulation without the features of the present invention is cumbersome and error-prone considering the number of users involved and the lack of links amongst the aforementioned constituents of each of the interactive simulation actions.

In some embodiments described herein, an editing tool is provided on a computer system for creating a simulation plan for an interactive computer simulation. The editing tool allows different constituents related to a prescribed maintenance action to be encoded for ordered development. For instance, the editing tool may provide a development process, which links the textual description of a maintenance manual to a corresponding interactive simulation procedure and behavior. The data is parsed from the maintenance guide provided for the actual system and can be analyzed in the editing tool to associate one or more simulated components to the prescribed maintenance action and specify what is to be performed during the interactive simulation. Supplemented input from different experts can be cascaded until completion of the development.

Each maintenance action typically consists of an actor, conducting an action on a subject that begin the interaction in an initial state, will be subject to various transitions depending on conditions and will end the interaction in a final state. The editing tool allows some mapping towards the simulation plan to be automatically associated with corresponding data structures in the simulation plan provided, e.g., by selecting an appropriate template. One after the other, each system specialist would complete the review of the simulation procedure in the editing tool and complete analysis of each relevant sections, supplementing the simulation plan with additional data on top of the previously define one. Once completed, the simulation plan captures the prescribed maintenance actions as per the perspective of each sub-system including all sub-system components, states and transitions.

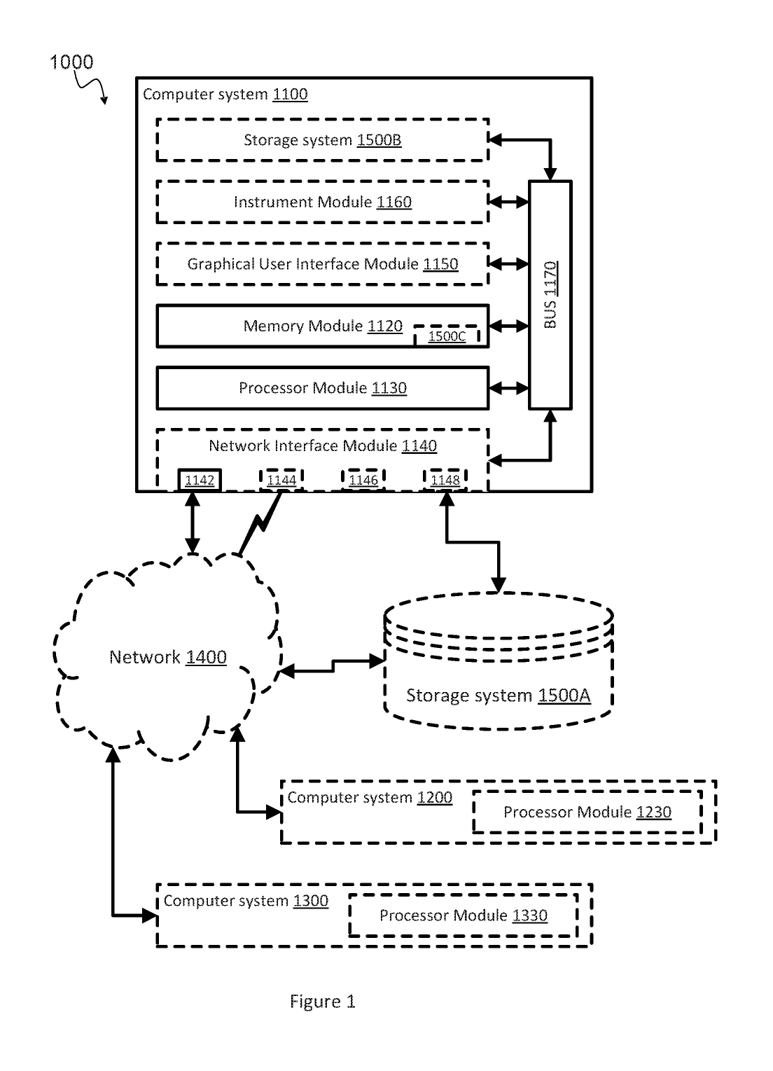

Reference is now made to the drawings, in which FIG. 1 shows a logical modular view of an exemplary computer system 1100 is depicted. The computer system 1100 is for creating or updating a simulation plan required for development of an interactive computer simulation of an interactive simulated system for training personnel on maintenance of a system corresponding to the interactive simulated system. The computer system comprises a processor module 1130, a memory module 1120 and a storage unit 1500. In the depicted embodiment of FIG. 1, a networked group of computers 1000 comprises the computer system 1100. The networked group of computers 1000 is depicted with additional computer systems 1200 and 1300 that each allow one or more users to contribute to the development of the interactive simulated maintenance procedure of the interactive computer simulation from the maintenance-action content. The computer systems 1100, 1200 and 1300 may be connected via a network 1400, via direct connections or a mix of direct and network connections. Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on links. Likewise, any number of routers and/or switches (not shown) may be present on links, which may further transit through the Internet.

The processor module(s) 1130, 1230 and/or 1330 may represent a single processor with one or more processor cores or an array of processors, each comprising one or more processor cores. The memory module 1120 may comprise various types of memory (different standardized or kinds of Random Access Memory (RAM) modules, memory cards, Read-Only Memory (ROM) modules, programmable ROM, etc.). The network interface module 1140 represents at least one physical interface that can be used to communicate with other network nodes. The network interface module 1140 may be made visible to the other modules of the computer system 1100 through one or more logical interfaces. The actual stacks of protocols used by the physical network interface(s) and/or logical network interface(s) 1142, 1144, 1146, 1148 of the network interface module 1140 do not affect the teachings of the present invention. The variants of processor module 1130, memory module 1120 and network interface module 1140 usable in the context of the present invention will be readily apparent to persons skilled in the art.

A bus 1170 is depicted as an example of means for exchanging data between the different modules of the computer system 1100. The present invention is not affected by the way the different modules exchange information between them. For instance, the memory module 1120 and the processor module 1130 could be connected by a parallel bus, but could also be connected by a serial connection or involve an intermediate module (not shown) without affecting the teachings of the present invention.

Likewise, even though explicit mentions of the memory module 1120 and/or the processor module 1130, or explicit mentions of other modules in the computer systems 1200 and 1300, are not made throughout the description of the various embodiments, persons skilled in the art will readily recognize that such modules are used in conjunction with other modules of the computer system 1100, 1200 and/or 1300 to perform routine as well as innovative steps related to the present invention. Similarly, more than three system 1100, 1200 and 1300 may typically be involved in the development and deployment of the interactive maintenance computer simulation, but only three are depicted for increased clarity and readability.

FIG. 1 shows examples of the storage unit as a distinct database system 1500A, a distinct module 1500B of the computer system 1100 or a sub-module 1500C of the memory module 1120 of the computer system 1100. The storage unit 1500 may be distributed over different systems A, B and/or C or may be in a single system. The storage unit 1500 may comprise one or more logical or physical as well as local or remote hard disk drive (HDD) (or an array thereof). The storage unit 1500 may further comprise a local or remote database made accessible to the computer system 1100 by a standardized or proprietary interface or via the network interface module 1140. The variants of storage unit 1500 usable in the context of the present invention will be readily apparent to persons skilled in the art.

The deployment of an interactive computer simulation developed in accordance with embodiments disclosed herein may be performed towards an interactive computer simulation system for training personnel on maintenance of the system. The interactive computer simulation system typically comprises one or more simulation stations that each allow one or more users to interact to control a simulated system in one of the interactive computer simulations of the interactive computer simulation system. In some embodiments, the computer system 1100 may also be able to perform as a simulation station (e.g., as a test environment or as a deployed environment). The simulation stations may be connected via the network 1400 or another network dedicated to simulation, via direct connections or a mix of direct and network connections. One or more tangible instrument module(s) (e.g., 1160) may be provided in the simulation stations for controlling the simulated system. The tangible instrument provided by the modules are tightly related to the system being simulated. In the example of maintenance of an aircraft, typical instruments include Depending on the type of simulation (e.g., level of immersivity), the tangible instruments may be more or less realistic compared to an system. While the present invention is applicable to immersive flat simulators certified for maintenance training, skilled persons will readily recognize and be able to apply its teachings to other types of computer simulations. A graphical user interface module of the simulation station (e.g., 1150) displays a rendered view of the simulated system and may further render additional information from the deployed interactive computer simulation (e.g., textual information or specific highlights mentioned in relevant simulated maintenance procedure(s) related to the rendered simulated system). While an interactive computer simulation of the simulated system is performed in the interactive computer simulation system, the storage unit (1500 or other dedicated system) may also log dynamic data in relation thereto. The logged information may then be used during debriefing of personnel train during the interactive computer simulation (e.g., individually), during planning of the training of a class of personnel, e.g., to identify trends or typical errors (collectively). The logged information may yet also provide feedback to improve or modify the OEM's maintenance manual, considering instinctive or initial responses from the trained personnel, considering typical errors and/or considering better, enhanced or simpler processes demonstrated by the trained personnel during the interactive computer simulation.

In a first set of embodiments, a simulation plan is created from a maintenance guide provided for the system.

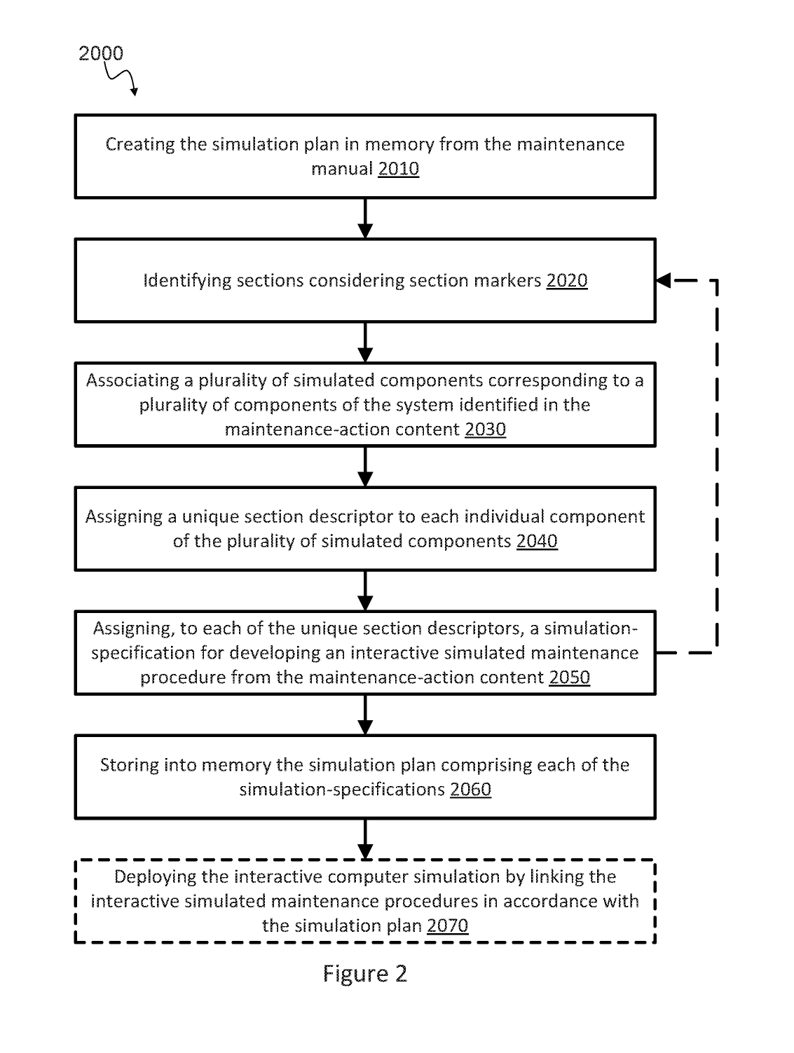

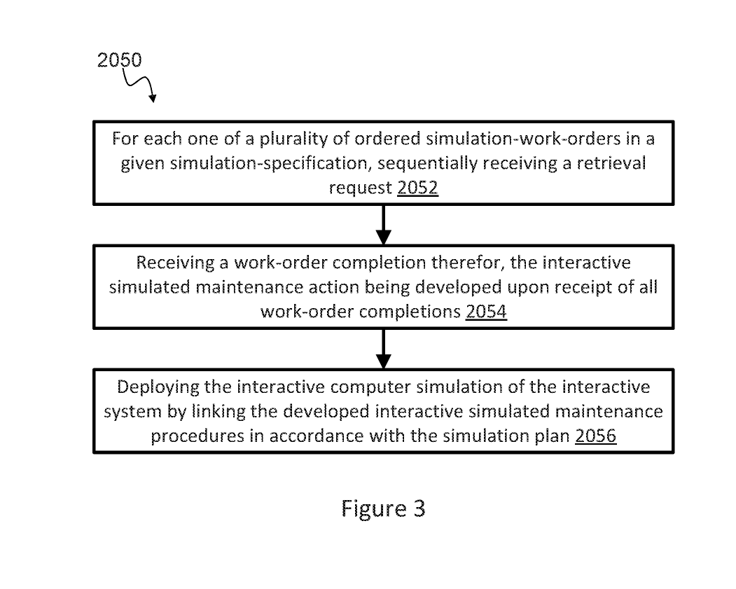

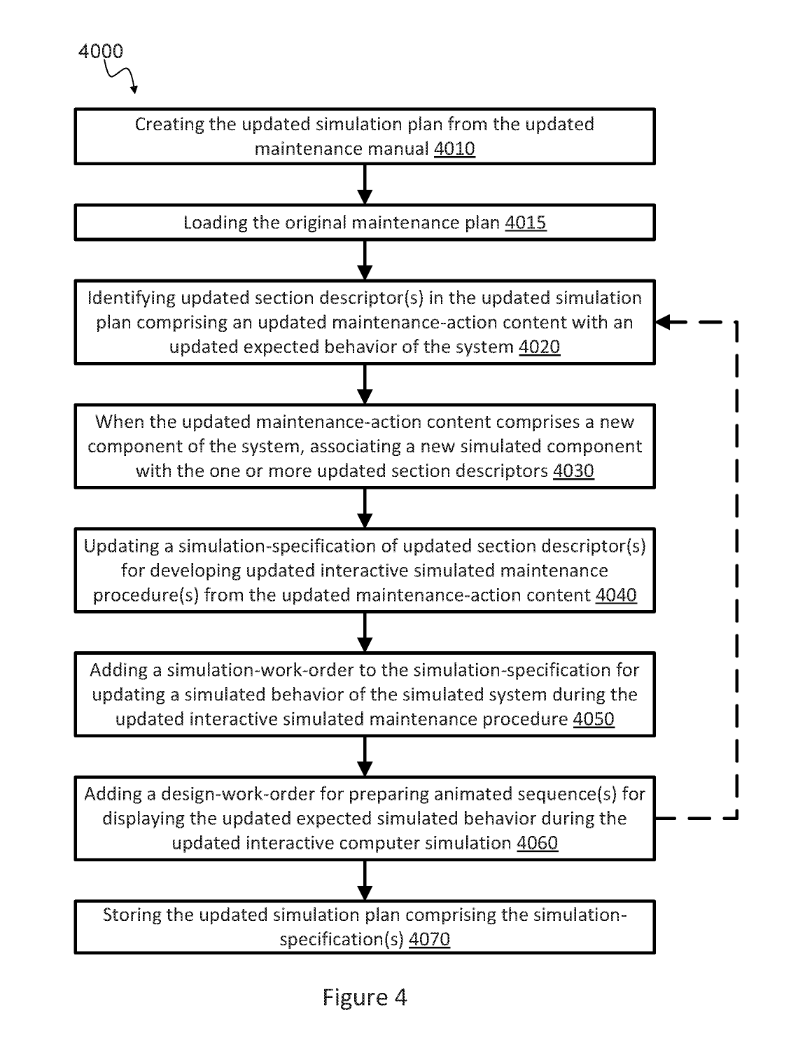

Reference is now concurrently made to FIG. 1 as well as FIGS. 2 and 3, which show a flow chart of an exemplary method 2000 for creating a maintenance plan in accordance with the first set of embodiments. The maintenance plan is created from a maintenance manual comprising a content describing maintenance actions to be performed on components of a system (e.g., a real aircraft such as an airbus A380). The simulation plan is required for subsequent deployment of an interactive computer simulation of an interactive simulated system (e.g., a simulated A380) for training personnel on maintenance of the real system. The method 2000 comprises creating 2010 into memory (e.g., 1500C) the simulation plan of the interactive simulated system preserving the content comprising section markers from the maintenance manual. Creating 2010 involves the processor module 1130. In some embodiments, the simulation plan is created 2010 by parsing the section markers in the maintenance plan. For instance, the maintenance manual may comprise marked-up language code, encoded document styles, formatting patterns and/or template markers. In some embodiments, the simulation plan is encoded with marked-up language (e.g., XML).

The method 2000 then follows with identifying 2020 a section in the simulation plan considering the section markers, the identified section comprising a maintenance-action content (e.g., through the processor module 1130). The identified section is then associated 2030 with a plurality of simulated components of the interactive simulated system corresponding to a plurality of components of the system identified in the maintenance-action content. The method 2000 then follows with assigning 2040 a unique section descriptor to each individual component of the plurality of simulated components. Afterwards, a simulation-specification is associated 2050 with assigning each of the unique section descriptors for developing an interactive simulated maintenance procedure of the interactive computer simulation from the maintenance-action content. The method 2000 continues with storing 2060 into memory the simulation plan comprising the simulation-specifications for the identified section. Development of the interactive computer simulation of the interactive system necessitates completion of every one of the simulation-specifications. In some embodiments, the simulated components or the unique section descriptors may be grouped considering an underlying common behavior thereof, an underlying common transition trigger for transition thereof and/or a common sub-system filiation thereof. The method 2000 may optionally further comprise deploying 2070 the interactive computer simulation of the interactive system by linking the developed interactive simulated maintenance procedures in accordance with the simulation plan.

In some embodiments of the first set of embodiments, the steps 2020, 2030, 204 and 2050 are repeated until all section markers from the content are parsed. The simulation-specification may comprise:
a simulated initial state of the individual simulated component before execution of the interactive simulated maintenance procedure corresponding to a state of a corresponding component from a corresponding group of components in an initial state from the maintenance-action content;
a simulated condition, associated with the individual simulated component, to be triggered during execution of the interactive simulated maintenance procedure, compatible with transition-conditions from the maintenance-action content;
a simulated transition of the individual simulated component, taking place upon trigger of the simulated condition, compatible with a transition of the group of components from the maintenance-action content; and
a simulated final stage of the individual simulated component after execution of the interactive simulated maintenance procedure, compatible a final state of the group of components from the maintenance-action content.

For instance, maintenance-action content may indicate “remove “part A” for inspection”. A simulation-specification for a corresponding simulated procedure may specify to remove “Part A” upon selection in the 3D scene in “Remove mode” and indicate that the “Part A” is seen being removed from the assembly and sent to a workbench for inspection. In this example, the initial state is “Part A” being at its original location in the simulated system. The simulated condition is a selection in “remove move”, the transition is the displacement towards the workbench and the final stage is the position of the “Part A” at the workbench.

In selected embodiments, assigning 2050 the unique section descriptor is performed by selecting a section template from a list of existing section templates considering an action type of the specific-action content (e.g., using the graphical user interface (GUI) module 1150). Assigning 2050 the unique section may also be performed by creating a new section template is using the graphical user interface (GUI) module 1150 considering an action type of the specific-action content and subsequently adding the new section template to a list of existing section templates.

Each of the simulation-specifications may also comprise a plurality of ordered simulation-work-orders. In the context of team development, assigning 2050 the simulation-specification may further comprise, for each one of the plurality of ordered simulation-work-orders, sequentially receiving 2052 a retrieval request therefor from a remote network node over a network interface. With reference to the example depicted in FIG. 1, retrieval requests may be received 2052 through the network interface module 1140 from the computer system 1200 and/or 1300.

Subsequently, a work-order completion shall be received 2054, from the remote network node over the network interface for each one of the retrieval requests (e.g., through the network interface module 1140 from the computer system 1200 and/or 1300). The interactive simulated maintenance procedure is considered fully developed upon receipt of each one of the work-order completions for each one of the plurality of ordered simulation-work-orders. The method 2000 may also further comprise deploying 2056 the interactive computer simulation of the interactive system by linking the developed interactive simulated maintenance procedures in accordance with the simulation plan.

The plurality of ordered simulation-work-orders may comprise:
a first system-work-order for indicating an expected behavior of the system considered during the specific-action content from the content of the maintenance manual;
a second simulation-work-order for indicating an expected simulated behavior of the simulated system during the interactive simulated maintenance procedure; and
a third design-work-order for preparing one or more simulated component's 3D visual representation and/or animated sequences for displaying the expected simulated behavior of the simulated system during the simulated maintenance procedure.

In some embodiments, assigning 2040 the unique section descriptor is performed using the graphical user interface (GUI) module 1150 that allows selection of a section template from a list of existing section templates considering an action type of the specific-action content. When necessary, the GUI module 1150 may also allow for creation of a new section template considering an action type of the specific-action content. Subsequently, the new section template may then be added to the list of existing section templates (e.g., for other projects or for other maintenance actions of the same project). Likewise, associating 2030 the simulated component with the unique section descriptor may be performed through the GUI module 1150 by selecting at least one of the one or more simulated components from a list of existing unique components of the interactive simulated system. When appropriate, the GUI module 1150 may also allow for selecting a new component for at least one of the one or more simulated components. The simulation-specification may then further comprise a creation request for creating the new component for the interactive simulated system. The new component may then be subsequently added to the list of existing unique components of the interactive simulated system.

In a second set of embodiments, an updated simulation plan is created, upon receipt of an updated maintenance guide, from an existing interactive simulation created from the original maintenance guide.

Reference is now concurrently made to FIG. 1 and FIG. 4, which shows a flow chart of an exemplary method 4000 in accordance with a second set of embodiments. The method 4000 allows updating an original simulation plan into an updated simulation plan considering an updated maintenance manual. The updated maintenance manual comprises an updated content describing one or more updated maintenance actions. The updated simulation plan is required for subsequent development of an updated interactive computer simulation of an interactive simulated system for training personnel on maintenance of the system. The method 4000 comprises creating 4010 into memory the updated simulation plan of the interactive simulated system preserving the updated content comprising section markers from the updated maintenance manual. The method 4000 also comprises loading 4015 into memory the original simulation plan comprising a plurality of original section descriptors. The original simulation plan is created from an original content preserved in the original simulation plan from an original maintenance manual for the system. Creating 4010 the updated simulation plan may comprise locating the section markers in the updated maintenance plan by parsing one or more of marked-up language code, encoded document styles, detecting formatting patterns or detecting template markers. The creation 4010 and load 4015 are performed using the processor module 1130.

The method 4000 also comprises identifying 4020 one or more updated section descriptors in the updated simulation plan considering the section markers and the plurality of original section descriptors. The updated simulation plan comprises an updated maintenance-action content, which indicates an updated expected behavior of the system. When the updated maintenance-action content comprises a new component of the system, a new simulated component is then associated 4030 with the one or more updated section descriptors.

The method 4000 then comprises with updating 4030 a simulation-specification of the one or more updated section descriptors for developing one or more updated interactive simulated maintenance procedures from the updated maintenance-action content.

The method 4000 is then followed with adding 4050 a simulation-work-order to the simulation-specification for updating a simulated behavior of the simulated system during the updated interactive simulated maintenance procedure and adding 4060 a design-work-order for preparing one or more animated sequences for displaying the updated expected simulated behavior of the simulated system during the updated interactive computer simulation. The updated simulation plan comprising the simulation-specification is then stored 4070. Development of the updated interactive computer simulation of the interactive system necessitates completion of the simulation-specification. The method 4000 may comprise repeating steps 4020, 4030, 4040, 4050 and 4060 for each of a plurality of updated sections in the updated simulation plan.

In some embodiments in accordance with the second set of embodiments, the method 4000 may further comprise copying each undisturbed section descriptors from the original simulation plan into the updated simulation plan. Storing 4070 the updated simulation plan may then comprise storing the undisturbed original section descriptors from the original simulation plan together with each one of the updated simulation-specifications for the one or more updated section descriptors.

Updating 4040 the unique section descriptor may be performed is performed using the graphical user interface (GUI) module 1150 that allows by selecting a section template from a list of existing section templates considering an action type of the specific-action content. The GUI module 1150 may also allow creation of a new section template considering an action type of the updated maintenance-action content and subsequently adding the new section template to a list of existing section templates.

In the context of team development, adding 4040 or 4050 the work-order may comprise, sequentially receiving 4052 a retrieval request therefor from a remote network node over a network interface. With reference to the example depicted in FIG. 1, retrieval requests may be received 4052 through the network interface module 1140 from the computer system 1200 and/or 1300.

Subsequently, a work-order completion shall be received 4054, from the remote network node over the network interface for each one of the retrieval requests (e.g., through the network interface module 1140 from the computer system 1200 and/or 1300). The interactive simulated maintenance procedure is considered fully developed upon receipt of each one of the work-order completions for each one of the plurality of work-orders. The method 4000 may also further comprise deploying 4056 the interactive computer simulation of the interactive system by linking the developed interactive simulated maintenance procedures in accordance with the simulation plan.

Associating 4030 the new simulated component with the one or more updated section descriptors may be performed using the GUI module 1150 by selecting the new simulated component from a list of existing unique components of the interactive simulated system. The GUI module 1150 may also be used for associating 4030 the new simulated component with the one or more updated section descriptors by including a creation request for creating the new simulated component for the interactive simulated system in the simulation-specification and subsequently adding the new simulated component to a list of existing unique components of the interactive simulated system.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A method for creating, from an Original Equipment Manufacturer (OEM) maintenance manual comprising a content describing maintenance actions to be performed on real components of a real multi-component OEM system, a corresponding simulation plan, the method comprising:
a) creating into memory the simulation plan of an interactive simulated multi-component system preserving the content comprising section markers from the maintenance manual of the real multi-component OEM system, wherein each of the section markers corresponds to one or more of the real components of the real multi-component OEM system, wherein the simulation plan is required for development of an interactive computer simulation of the interactive simulated multi-component system for training personnel on maintenance of the real multi-component OEM system;
b) identifying a section in the simulation plan considering the section markers, the identified section comprising a maintenance-action content from the maintenance manual for the one or more components of the real multi-component OEM system;
c) associating, with the identified section, a plurality of simulated components of the interactive simulated multi-component system corresponding to the one or more components of the real multi-component OEM system identified in the maintenance-action content from the maintenance manual of the real multi-component OEM system;
d) assigning a unique section descriptor to each individual simulated component of the plurality of simulated components;
e) assigning, to each of the unique section descriptors, a simulation-specification for developing an interactive simulated maintenance procedure of the interactive computer simulation from the maintenance-action content from the maintenance manual of the real multi-component OEM system; and
f) storing into memory the simulation plan comprising the simulation-specifications for the identified section, wherein development of the interactive computer simulation of the interactive system necessitates completion of every one of the simulation-specifications and wherein the training of the personnel on maintenance of the real multi-component OEM system necessitates completion of the development of the interactive computer simulation of the interactive system.

2. The method of claim 1, further comprising grouping at least two of the unique section descriptors of the individual simulated components considering one or more of an underlying common behavior thereof, an underlying common transition trigger for transition thereof and a common sub-system filiation thereof.

3. The method of claim 1, wherein the simulation-specification comprises:
a simulated initial state of the individual simulated component before execution of the interactive simulated maintenance procedure corresponding to a state of a corresponding real component from a corresponding group of real components in an initial state from the maintenance-action content from the maintenance manual of the real multi-component OEM system;
a simulated condition, associated with the individual simulated component, to be triggered during execution of the interactive simulated maintenance procedure, compatible with transition-conditions of the group of real components from the maintenance-action content from the maintenance manual of the real multi-component OEM system;
a simulated transition of the individual simulated component, taking place upon trigger of the simulated condition, compatible with a transition of the group of real components from the maintenance-action content from the maintenance manual of the real multi-component OEM system; and
a simulated final stage of the individual simulated component after execution of the interactive simulated maintenance procedure, compatible a final state of the group of real components from the maintenance-action content from the maintenance manual of the real multi-component OEM system.

4. The method of claim 1, wherein creating into memory the simulation plan further comprises locating the section markers in the maintenance manual of the real multi-component OEM system by parsing one or more of marked-up language code, encoded document styles, detecting formatting patterns or detecting template markers, the simulation plan being encoded with marked-up language.

5. The method of claim 1, wherein assigning the unique section descriptor is performed by selecting a section template from a list of existing section templates considering an action type of the specific-action content.

6. The method of claim 1, wherein assigning the unique section is performed by creating a new section template considering an action type of the specific-action content and subsequently adding the new section template to a list of existing section templates.

7. The method of claim 1, further comprising repeating b) to e) until all section markers from the content from the maintenance manual of the real multi-component OEM system are parsed.

8. The method of claim 1, wherein each of the simulation-specifications comprises a plurality of ordered simulation-work-orders, the method further comprising, for each one of the plurality of ordered simulation-work-orders:
sequentially receiving a retrieval request therefor from a remote network node over a network interface;
subsequently receiving, from the remote network node over the network interface, a work-order completion therefor; and
wherein the interactive simulated maintenance procedure is developed upon receipt of each one of the work-order completions for each one of the plurality of ordered simulation-work-orders.

9. The method of claim 8, wherein the plurality of ordered simulation-work-orders comprise:
a first system-work-order for indicating an expected behavior of the multi-component system considered during the specific-action content from the content of the maintenance manual of the real multi-component OEM system;
a second simulation-work-order for indicating an expected simulated behavior of the simulated multi-component system during the interactive simulated maintenance procedure; and
a third design-work-order for preparing one or more animated sequences for displaying the expected simulated behavior of the simulated multi-component system during the simulated maintenance procedure.

10. The method of claim 8, further comprising deploying the interactive computer simulation of the interactive system by linking the developed interactive simulated maintenance procedures in accordance with the simulation plan.

11. The method of claim 1, wherein associating the one or more simulated components with the unique section descriptor is performed by selecting at least one of the one or more simulated components from a list of existing unique simulated components of the interactive simulated multi-component system.

12. The method of claim 1, wherein associating the one or more simulated components with the unique section descriptor is performed by selecting a new simulated component for at least one of the one or more simulated components and wherein the simulation-specification comprises a creation request for creating the new simulated component for the interactive simulated multi-component system and subsequently adding the new simulated component to a list of existing unique simulated components of the interactive simulated multi-component system.

13. A computer system for creating a simulation plan required for development of an interactive computer simulation of an interactive simulated multi-component system, the computer system comprising:
a storage unit storing:
a maintenance manual, provided by an Original Equipment Manufacturer (OEM), comprising a content describing maintenance actions to be performed on real components of a real multi-component OEM system; and
the simulation plan of the interactive simulated multi-component system preserving the content comprising section markers from the maintenance manual of the real multi-component OEM system, wherein each of the section markers corresponds to one or more of the real components of the real multi-component OEM system, wherein the simulation plan is required for development of an interactive computer simulation for training personnel on maintenance of the real multi-component OEM system corresponding to the interactive simulated multi-component system of the interactive computer simulation; and
a processor module that:
a) identifies a section in the simulation plan considering the section markers, the identified section comprising a maintenance-action content from the maintenance manual of the real multi-component OEM system;
b) associates, with the identified section, a plurality of simulated components of the interactive simulated system corresponding to the one or more real components of the real multi-component OEM system identified in the maintenance-action content from the maintenance manual for the one or more components of the real multi-component OEM system;
c) assigns a unique section descriptor to each individual simulated component of the plurality of simulated components;
d) assigns, to each of the unique section descriptors, a simulation-specification for developing an interactive simulated maintenance procedure of the interactive computer simulation from the maintenance-action content from the maintenance manual of the real multi-component OEM system; and
e) updates, into the storage unit, the stored simulation plan comprising each one of the simulation-specifications for each one of the identified sections, wherein development of the interactive computer simulation of the interactive system necessitates completion of every one of the simulation-specifications and wherein the training of the personnel on maintenance of the real multi-component OEM system necessitates completion of the development of the interactive computer simulation of the interactive system.

14. The computer system of claim 13, wherein the processor module further groups at least two of the unique section descriptors of the individual simulated components considering one or more of an underlying common behavior thereof, an underlying common transition trigger for transition thereof and a common sub-system filiation thereof.

15. The computer system of claim 13, wherein the simulation-specification comprises:
a simulated initial state of the individual simulated component before execution of the interactive simulated maintenance procedure corresponding to a state of a corresponding real component from a corresponding group of real components in an initial state from the maintenance-action content from the maintenance manual of the real multi-component OEM system;
a simulated condition, associated with the individual simulated component, to be triggered during execution of the interactive simulated maintenance procedure, compatible with transition-conditions of the group of real components from the maintenance-action content from the maintenance manual of the real multi-component OEM system;
a simulated transition of the individual simulated component, taking place upon trigger of the simulated condition, compatible with a transition of the group of real components from the maintenance-action content from the maintenance manual of the real multi-component OEM system; and
a simulated final stage of the individual simulated component after execution of the interactive simulated maintenance procedure, compatible a final state of the group of real components from the maintenance-action content from the maintenance manual of the real multi-component OEM system.

16. The computer system of claim 13, wherein the maintenance manual of the real multi-component system of the OEM stored in the storage unit further comprises one or more of marked-up language code, encoded document styles, formatting patterns or template markers and the simulation plan stored in the storage unit is encoded with marked-up language.

17. The computer system of claim 13, wherein the processor module assigns the unique section descriptor by:
selecting a section template from a list of existing section templates considering an action type of the specific-action content; and
when no section template is selected, creating a new section template considering an action type of the specific-action content and subsequently adding the new section template to a list of existing section templates.

18. The computer system of claim 13, wherein each of the simulation-specifications comprises a plurality of ordered simulation-work-orders and wherein the processor module further, for each one of the plurality of ordered simulation-work-orders:
sequentially receives a retrieval request therefor from a remote network node over a network interface; and
subsequently receives, from the remote network node over the network interface, a work-order completion therefor; and
wherein the interactive simulated maintenance procedure is developed upon receipt of each one of the work-order completions for each one of the plurality of ordered simulation-work-orders.

19. The computer system of claim 18, wherein the plurality of ordered simulation-work-orders comprise:
a first system-work-order for indicating an expected behavior of the system considered during the specific-action content from the content of the maintenance manual of the real multi-component OEM system;
a second simulation-work-order for indicating an expected simulated behavior of the simulated system during the interactive simulated maintenance procedure; and
a third design-work-order for preparing one or more animated sequences for displaying the expected simulated behavior of the simulated system during the simulated maintenance procedure.

20. The computer system of claim 18, wherein the processor module further deploys the interactive computer simulation of the interactive system by linking the developed interactive simulated maintenance procedures in accordance with the simulation plan.
